(19) United States
(12) Patent Application Publication
(10) Pub. No.: US 2026/0144231 A1
(43) Pub. Date: May 28, 2026

(54) ANIMAL NAIL CLIPPER

(71) Applicant: Suzanne Gabrielle Gallant, Cornwall (CA)

(72) Inventor: Suzanne Gabrielle Gallant, Cornwall (CA)

(21) Appl. No.: 18/959,562

(22) Filed: Nov. 25, 2024

(51) Int. Cl. A01K 13/00; A45D 29/02

(52) U.S. Cl. CPC A01K 13/00; A45D 29/02

(57) ABSTRACT

An animal nail clipper that is configured to provide trimming of an animal's nails wherein the body thereof is manufactured to permit the user to hide a portion thereof in the palm area of their hand during use. The nail clipper includes a first jaw member and a second jaw member each having cutting edges configured to trim a nail. The first jaw member and second jaw member are pivotally coupled with a pivot member. A first handle member is operably coupled to the first jaw member. The first handle member includes an upper surface having a depression for engagement of the thumb. A second handle member is operably coupled to the second jaw member extending rearward therefrom being elongated and arcuate in shape. A ring member is operably coupled to the first handle member and is movable between a first position and a second position.

### FIELD OF THE INVENTION

The present invention relates generally to animal care implements, more specifically but by way of limitation, a nail clipper configured to trim nails of an animal such as but not limited to a dog, wherein the present invention includes handle members operably coupled to the jaw portion that are constructed to be concealed by the hand of the user.

### BACKGROUND

Veterinary visits are a necessary aspect of pet ownership, yet many dogs exhibit signs of anxiety and fear when faced with the prospect of a trip to the veterinarian. This fear can be distressing not only for the animals but also for their owners and veterinary staff. Understanding the roots of this anxiety, its manifestations, and strategies for mitigation can help create a more positive experience for both dogs and their caregivers. The fear that dogs experience at veterinary clinics can be attributed to several factors. Firstly, the unfamiliar environment plays a significant role. The sounds of barking, strange smells, and the presence of other animals can create a chaotic atmosphere that overwhelms a dog's senses. Additionally, many dogs associate veterinary visits with discomfort or pain from past experiences, such as vaccinations or examinations. This conditioning can lead to anticipatory anxiety, where dogs become fearful even before entering the clinic. Moreover, the social dynamics of a veterinary visit can exacerbate anxiety. Dogs are social animals, and the presence of unfamiliar people and pets can induce stress. The inability to predict the outcome of a visit can also contribute to a dog's anxiety, as they may not understand that a trip to the vet is for their health and well-being.

The manifestations of fear in dogs during veterinary visits can vary widely. Common signs include vocalization, trembling, excessive panting, attempts to escape, and even aggression. These behaviors not only indicate a dog's discomfort but can also complicate the examination process, making it challenging for veterinary staff to provide necessary care. For some dogs, the fear response can lead to long-term aversion to veterinary visits. This cycle of fear can create a barrier to regular veterinary care, ultimately impacting a dog's health and well-being. To address the fear that dogs experience at the veterinarian, several strategies can be implemented. First and foremost, positive reinforcement training can help desensitize dogs to the clinic environment. Owners can begin by taking their dogs to the clinic for non-threatening visits, allowing them to explore the space without the stress of an examination. Rewarding calm behavior with treats and praise can create positive associations with the clinic. Furthermore, the use of calming products, such as pheromone diffusers or anxiety wraps, can provide additional support for anxious pets. Utilization of tools that can either be hidden or are non-threatening can help ease the anxiety of the dog. By understanding the roots of this anxiety and implementing strategies to mitigate it, owners and veterinary professionals can work together to create a more positive experience for canine patients.

Accordingly, there is a need for a pet nail trimmer that is configured to be concealed by a user's hand so as to reduce the anxiety of the pet during trimming of the nails.

### SUMMARY OF THE INVENTION

It is the object of the present invention to provide a nail trimmer for an animal that is configured to be substantially concealed by a user's hand wherein the present invention includes a jaw member having a first jaw and a second jaw.

Another object of the present invention is to provide a tool utilized to trim the nails of an animal wherein the first jaw member includes a handle member integrally formed therewith.

A further object of the present invention is to provide a nail trimmer for an animal that is configured to be substantially concealed by a user's hand wherein the second jaw member includes a handle member integrally formed therewith.

Yet a further object of the present invention is to provide a tool utilized to trim the nails of an animal wherein the first handle member and second handle member fits between the index and middle finger of a user extending inward towards the palm area of the hand.

Still another object of the present invention is to provide a nail trimmer for an animal that is configured to be substantially concealed by a user's hand wherein the first handle member includes a semi-annular portion having a depression for engagement by the thumb of the user.

An additional object of the present invention is to provide a tool utilized to trim the nails of an animal wherein the first jaw member and second jaw member are biased in an open position.

Yet a further object of the present invention is to provide a nail trimmer for an animal that is configured to be substantially concealed by a user's hand wherein the present invention can further includes an attachment configured to retain a toy or treat.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side perspective view of the present invention being held by a user; and

FIG. 2 is a side perspective view of an embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an animal nail clipper 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

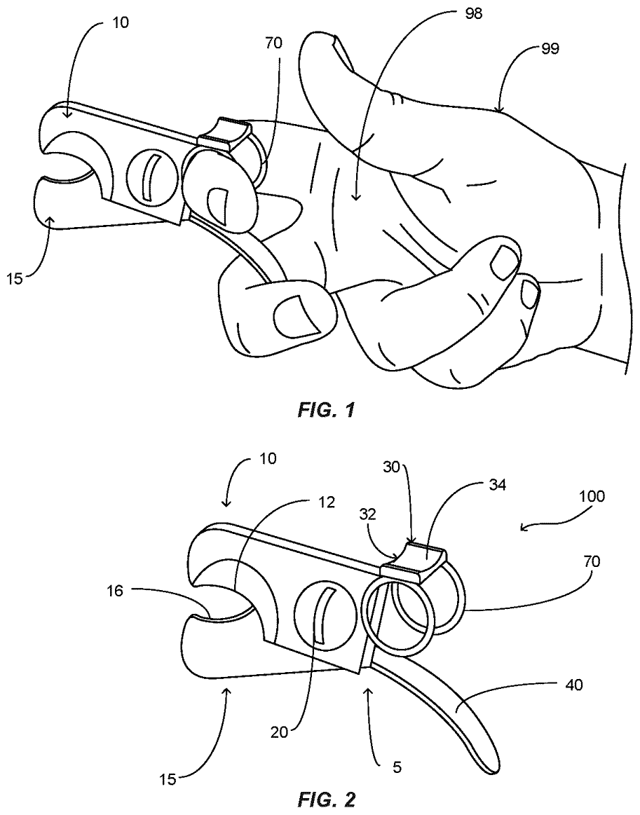

Referring in particular to the Figures submitted herewith, the animal nail clipper 100 is designed to be small so as to be substantially hidden by a user's hand when in use. FIG. 1 demonstrates one manner in which the animal nail clipper 100 can be held but it should be understood within the scope of the present invention that the animal nail clipper 100 could be held in a manner wherein the rear portion 5 is in the palm area 98 of the hand 99. FIG. 1 shows the ring members 70 in their first position wherein use thereof can be for engaging the animal nail clipper 100. The ring members 70 as is further discussed herein, are movable to a second position wherein the ring members 70 are oriented in an upwards direction and can be used to attach other items thereto.

The animal nail clipper 100 includes a first jaw member 10 and a second jaw member 15. The first jaw member 10 includes cutting edge 12 and the second jaw member 15 includes cutting edge 16. The first jaw member 10 and second jaw member 15 are operably coupled with pivot member 20. The first jaw member 10 and second jaw member 15 are movable between an open and closed position utilizing pivot member 20. The animal nail clipper 100 is illustrated herein with the first jaw member 10 and second jaw member 15 in an open position. In the closed position, the cutting edge 12 and cutting edge 16 are adjacent each other wherein movement to the closed position facilitates trimming of a nail that is intermediate the cutting edge 12 and cutting edge 16. It should be understood within the scope of the present invention that the first jaw member 10 and second jaw member 15 are maintained in in a biased open position with pivot member 20.

The first jaw member 10 has integrally formed therewith a first handle member 30. First handle member 30 is integrally formed utilizing suitable techniques. The first handle member 30 includes an upper surface 32 having depression 34. Depression 34 is concave in form and is configured to provide engagement with the thumb 96 for operation of the animal nail clipper 100. It should be understood within the scope of the present invention that the first handle member 30 could be manufactured in alternate sizes and shapes and achieve the desired objective discussed herein.

Operably coupled to the first handle member 30 are ring members 70. The ring members 70 are movably coupled to the first handle member 30 utilizing suitable techniques. The ring members 70 movable between a first position and a second position. In the first position, illustrated herein, the ring members 70 are positioned to extend downward from the first handle member 30. In the second position(not illustrated herein) the ring members 70 are positioned so as to extend upward from the first handle member 30. In the second position, the ring members 70 can be utilized to attached a toy or treat thereto in and aid to distract the animal during utilization of the animal nail clipper 100 for trimming the animals'nails. It should be understood within the scope of the present invention that the animal nail clipper 100 could be manufactured with or without the ring members 70. Furthermore, it should be understood within the scope of the present invention that the animal nail clipper 100 could have only one ring member 70.

The second jaw member 15 has operably coupled thereto a second handle member 40. The second handle member 40 extends away from the second jaw member 15 and is operably coupled thereto utilizing suitable techniques. The second handle member 40 is elongated in shape being arcuate so as to extend slightly downward from the second jaw member 15. The second handle member 40 can be utilized as is illustrated herein in FIG. 1, or placed in the palm area 98 when the animal nail clipper 100 is being held in an alternate manner. While the second handle member 40 is illustrated in an embodiment herein, it should be understood within the scope of the present invention that the second handle member 40 could be manufactured in alternate sizes and shapes in order to achieve the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An animal nail clipper constructed so as to have a substantial portion thereof hidden by a hand of a user wherein the animal nail clipper comprises:
a body, said body having a first jaw member, said first jaw member having a cutting edge, said body having a second jaw member, said second jaw member having a cutting edge, said first jaw member and said second jaw member being operably coupled with a pivot member, said body further including a first handle member, said first handle member being operably coupled to said first jaw member, said first handle member being proximate a rear end of said body, said first handle member being planar in orientation, said first handle member configured to be engaged by a thumb of a hand of the user, said body having a second handle member, said second handle member being operably coupled to said second jaw member, said second jaw member being proximate the rear of said body, said second handle member extending rearward of said body and outward therefrom.

2. The animal nail clipper constructed so as to have a substantial portion thereof hidden by a hand of a user as recited in claim 1, wherein said first handle member includes an upper surface.

3. The animal nail clipper constructed so as to have a substantial portion thereof hidden by a hand of a user as recited in claim 2, wherein said upper surface of said first handle member has a concave depression formed thereon.

4. The animal nail clipper constructed so as to have a substantial portion thereof hidden by a hand of a user as recited in claim 3, wherein said second handle member is elongated and arcuate in form.

5. The animal nail clipper constructed so as to have a substantial portion thereof hidden by a hand of a user as recited in claim 4, and further including at least one ring member, said at least one ring member being operably coupled to said first handle member.

6. The animal nail clipper constructed so as to have a substantial portion thereof hidden by a hand of a user as recited in claim 5, wherein said at least one ring member is movable between a first position and a second position.

7. The animal nail clipper constructed so as to have a substantial portion thereof hidden by a hand of a user as recited in claim 6, wherein in said first position said at least one ring member is extending downward from said first handle member.

8. The animal nail clipper constructed so as to have a substantial portion thereof hidden by a hand of a user as recited in claim 7, wherein in said second position said at least one ring member is extending upward from said first handle member.
